(19) United States
(12) Patent Application Publication
(10) Pub. No.: US 2024/0387793 A1
(43) Pub. Date: Nov. 21, 2024

(54) ELECTRODE MANUFACTURING APPARATUS

(71) Applicant: Prime Planet Energy & Solutions, Inc., Tokyo (JP)

(72) Inventor: Shun YAMAZAKI, Himeji-shi (JP)

(21) Appl. No.: 18/645,378

(22) Filed: Apr. 25, 2024

(30) Foreign Application Priority Data
May 15, 2023 (JP) 2023-080343

(51) Int. Cl. H01M 4/04; B23K 26/00; B23K 26/38; B23K 26/70; B23K 101/38

(52) U.S. Cl. CPC H01M 4/0435; B23K 26/0093; B23K 26/38; B23K 26/70; B23K 2101/38

(57) ABSTRACT

An electrode manufacturing apparatus includes a conveyor device conveying an electrode sheet, a compression device, a tab formation device, and a controller. The electrode sheet includes a strip-shaped current collector foil in which an uncoated portion is defined along a lengthwise direction in at least one widthwise end portion of the electrode sheet, and an electrode active material layer formed on a portion of the strip-shaped current collector foil that is other than the uncoated portion. The compression device includes a pair of pressure rollers sandwiching the electrode sheet and compressing the electrode active material layer. The tab formation device applies laser light to the electrode sheet to form tabs in a predetermined shape at a predetermined pitch. The controller is configured to control a laser trajectory for the tab formation device based on a pressing pressure of the compression device.

### CROSS REFERENCE TO RELATED APPLICATIONS

The present application claims priority from Japanese Patent Application No. 2023-080343 filed on May 15, 2023, which is incorporated by reference herein in its entirety.

### BACKGROUND

The present disclosure relates to an electrode manufacturing apparatus.

JP 2021-26982 A discloses an electrode sheet that has, in a shorter axis direction of a long sheet-shaped metal foil, a coated portion in which the metal foil and an active material layer are present and an exposed portion in which the active material layer is absent and the metal foil is exposed. The electrode sheet disclosed in the publication has a penetrating portion penetrating the exposed portion and a reinforcing layer present on the exposed portion. The penetrating portion has an inner end portion at an end of the metal foil that is located nearer to the active material layer in the shorter axis direction of the metal foil. The reinforcing layer is located between the inner end portion and the coated portion in the shorter axis direction of the metal foil. It is stated that such an electrode sheet enables the penetrating portion to absorb the difference between the amount of elongation of the coated portion and the amount of elongation of the exposed portion when the coated portion is pressed by press rolls. It is stated that this reduces wrinkles in the exposed portion.

### SUMMARY

The present inventor intends to stabilize the processing of tabs formed on the electrode sheet.

An electrode manufacturing apparatus according to the present disclosure includes a conveyor device conveying an electrode sheet, a compression device compressing the electrode sheet conveyed by the conveyor device, a tab formation device forming tabs on the electrode sheet conveyed by the conveyor device after the electrode sheet is compressed by the compression device, and a controller. The electrode sheet includes a strip-shaped current collector foil in which an uncoated portion is defined along a lengthwise direction in at least one widthwise end portion of the electrode sheet, and an electrode active material layer formed on a portion of the strip-shaped current collector foil that is other than the uncoated portion. The compression device includes a pair of pressure rollers sandwiching the electrode sheet and compressing the electrode active material layer. The tab formation device applies laser light to the electrode sheet and forms tabs with a predetermined shape at a predetermined pitch. The controller is configured to control a laser trajectory of the tab formation device based on a pressing pressure of the compression device. The just-described electrode manufacturing apparatus achieves stable processing of the tabs formed on the electrode sheet.

### BRIEF DESCRIPTION OF THE DRAWINGS

FIG. 1 is a schematic view illustrating an electrode manufacturing apparatus 1.

FIG. 2 is a schematic view of an electrode sheet 10.

FIG. 3 is a schematic view illustrating a tab formation device 60.

FIG. 4 is a graph illustrating the relationship between the pressing pressure and the elongation of a current collector foil.

FIG. 5 is a graph illustrating the relationship between the deformation amount of a current collector foil 12 and the correction amount of the pitch between tabs 12b.

FIG. 6 is a graph illustrating the relationship between the radius of an electrode sheet and the elongation of a current collector foil.

### DETAILED DESCRIPTION

Hereinbelow, embodiments of the technology according to the present disclosure will be described with reference to the drawings. It should be noted, however, that the disclosed embodiments are, of course, not intended to limit the disclosure. The drawings are depicted schematically and do not necessarily accurately depict actual objects. The features and components that exhibit the same effects are designated by the same reference symbols as appropriate, and the description thereof will not be repeated as appropriate.

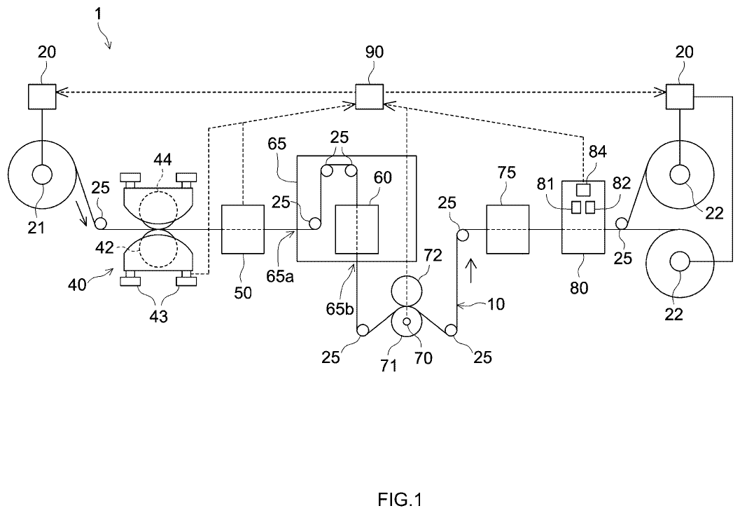

FIG. 1 is a schematic view illustrating an electrode manufacturing apparatus 1. FIG. 1 schematically shows the electrode manufacturing apparatus 1 as viewed along a widthwise direction of an electrode sheet 10.

### Electrode Manufacturing Apparatus 1

As illustrated in FIG. 1, the electrode manufacturing apparatus 1 includes a conveyor device 20, a compression device 40, a film thickness gauge 50, a tab formation device 60, a shape acquisition device 80, and a controller 90. The electrode manufacturing apparatus 1 includes a feed roller 21 from which the electrode sheet 10 is rolled out, and winding rollers 22 on which the electrode sheet 10 is taken up. The electrode manufacturing apparatus 1 manufactures an electrode sheet 10 that configures an electricity storage device. The electrode sheet 10 constitutes a positive electrode sheet or a negative electrode sheet of an electrode assembly that is to be accommodated in the inside of the electricity storage device. The term “electricity storage device” refers to a repeatedly chargeable device, and it is intended to encompass what is called storage batteries (chemical cells), such as lithium-ion secondary batteries, nickel-metal hydride batteries, and nickel-cadmium batteries, as well as capacitors (i.e., physical cells) such as electric double-layer capacitors. Hereinafter, an example of the electrode manufacturing apparatus 1 for manufacturing an electrode sheet 10 is described, as well as the configuration of the electrode sheet 10 that is used for lithium-ion secondary batteries.

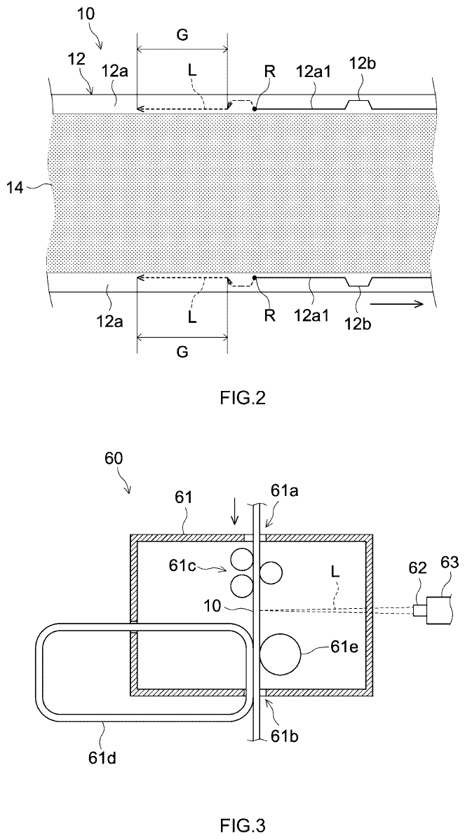

FIG. 2 is a schematic view of an electrode sheet 10. FIG. 2 illustrates how tabs 12b are formed on the electrode sheet 10. In FIG. 2, the direction in which the electrode sheet 10 is conveyed is indicated by the arrow. As illustrated in FIG. 2, the electrode sheet 10 includes a current collector foil 12 and an electrode active material layer 14.

The current collector foil 12 is an oblong strip-shaped metal member. For the current collector foil 12, it is possible to use a metal material that has required electrical conductivity. For a positive electrode current collector foil, it is possible use, for example, aluminum, aluminum alloys, or the like. For a negative electrode current collector foil, it is possible to use, for example, copper, copper alloys, or the like. The electrode active material layer 14 is formed on at least one surface of the strip-shaped current collector foil 12. In this embodiment, the electrode active material layer 14 is formed on both surfaces of the current collector foil 12. The electrode active material layer 14 is a layer containing an electrode active material. For a positive electrode active material, it is possible to use, for example, lithium-transition metal composite oxides. For a negative electrode active material, it is possible to use, for example, carbon materials, silicon based materials, and composite oxides thereof. The active material layer may also contain additive agents other than the electrode active material, such as binders and conductive agents.

The electrode sheet 10 is formed by coating an electrode mixture slurry, which forms the electrode active material layer 14, onto the current collector foil 12, and drying. The current collector foil 12 is provided with uncoated portions 12a. The uncoated portions 12a are defined along a lengthwise direction in widthwise end portions. In this embodiment, uncoated portions 12a are defined at both widthwise ends. The electrode mixture slurry is coated onto a portion of the current collector foil 12 that is other than the uncoated portions 12a. As a result, the electrode active material layer 14 is formed on the portion of the current collector foil 12 that is other than the uncoated portions 12a.

The coating of the current collector foil with the electrode active material layer may be performed using a known coating device. For the coating device, it is possible to use, for example, a slit coater, a gravure coater, a die-coater, a comma coater, or the like. The electrode active material layer 14 may be coated on a surface of the current collector foil 12 that is opposite the surface thereof that is supported by a backup roller, with the current collector foil 12 being supported by the backup roller. A dryer device for drying the electrode active material layer 14 that is coated on the current collector foil 12 may be provided downstream of the coating device. For the dryer device, it is possible to use a device that dries the electrode active material layer 14 with hot air, infrared rays, or the like.

As illustrated in FIG. 1, the electrode sheet 10 is wound on the feed roller 21. The electrode sheet 10 is conveyed along a predetermined conveyance passage and is taken up on the winding rollers 22. The feed roller 21 and the winding rollers 22 may be fitted to an autosplicing device that replaces the respective rollers that have completed feeding and winding with new rollers. The feed roller 21 and the winding rollers 22 are driven by the conveyor device 20. Although not shown in detail in the drawings, the electrode manufacturing apparatus 1 is set with a conveyance passage in which the electrode sheet 10 is conveyed. The conveyance passage may be set by rollers 25, such as guide rollers, dancer rollers, and feed rollers, for example.

### Conveyor Device 20

The conveyor device 20 conveys the electrode sheet 10. Although not particularly limited thereto, the conveying speed of the electrode sheet 10 may be set to about 30 m/minute to about 150 m/minute. This embodiment uses a motor as the conveyor device 20. The conveyor device 20 drives the feed roller 21 and the winding rollers 22 to rotate so as to be able to convey the electrode sheet 10 at a predetermined conveying speed. The rotational speed of the feed roller 21 and the winding rollers 22, which are driven by the conveyor device 20, may be controlled by the controller 90. The rotational speed of the feed roller 21 and the winding rollers 22 may be controlled according to a predetermined program so as to be constant with the conveying speed of the electrode sheet 10. The rotational speed of the feed roller 21 and the winding rollers 22 may be controlled corresponding to the amount of the electrode sheet 10 wound on the feed roller 21 and the winding rollers 22. The electrode sheet 10 that is wound out from the feed roller 21 is conveyed toward the compression device 40.

It is also possible that a foreign matter removal device, not shown, may be provided between the compression device 40 and the feed roller 21. The electrode sheet 10 that is rolled out from the feed roller 21 is conveyed to the foreign matter removal device. For the foreign matter removal device, it is possible to use a device that can remove foreign objects on the surface of the electrode sheet 10 in a contact or non-contact manner. The electrode sheet 10 that has passed through the foreign matter removal device is conveyed to the compression device 40.

### Compression Device 40

The compression device 40 compresses the electrode sheet 10 conveyed by the conveyor device 20. The electrode active material layer 14 on the electrode sheet 10 may be compressed by the compression device 40 so as to be adjusted to have a required thickness and density. The compression device 40 includes a pair of pressure rollers 42 and 44. The electrode sheet 10 is sandwiched by the pair of pressure rollers 42 and 44. The electrode sheet 10 is rolled by being passed through the gap between the pair of pressure rollers 42 and 44, so that the electrode active material layer 14 on the electrode sheet 10 is compressed.

Of the pair of pressure rollers 42 and 44, the pressure roller 42 is disposed below and the pressure roller 44 is disposed above. The pressure rollers 42 and 44 are configured to be rotated by a rotary driving device, not shown. The electrode sheet 10 is conveyed between the pressure rollers 42 and 44. The gap between the pressure rollers 42 and 44 is set to be narrower than the thickness of the electrode sheet 10 that is not yet compressed. This allows the electrode sheet 10 to be conveyed by the pressure rollers 42 and 44 while being compressed by the pressure rollers 42 and 44. The electrode sheet 10 is conveyed and compressed substantially horizontally relative to the gap between the pressure rollers 42 and 44.

The thickness of the electrode active material layer 14 formed on the electrode sheet 10 before compression can vary depending on the amount of electrode mixture slurry that is coated. The amount of the coated electrode mixture slurry is not necessarily uniform within the surface of the electrode sheet 10. In addition, friction heat may be generated in the bearings of the rotary shafts of the pressure rollers 42 and 44 due to rotation of the pressure rollers 42 and 44. The friction heat may cause the pressure rollers 42 and 44 to expand nonuniformly. Thus, depending on conditions of the electrode active material layer 14, conditions of the pressure rollers 42 and 44, or the like, the thickness of the electrode sheet 10 after compression may in some cases not become uniform. The compression device 40 is provided with a mechanism that reduces variations in the thickness of the electrode sheet 10. In this embodiment, the thickness of the electrode sheet 10 is adjusted by controlling the gap between the pressure rollers 42 and 44. The mechanism that reduces variations in the thickness of the electrode sheet 10 is not limited to any particular mechanism but may be implemented by a mechanism that controls the pressing pressure acting on the electrode sheet 10.

Variations in thickness of the electrode active material layer 14 may be reduced by adjusting the pressing pressure to the electrode sheet 10. In this embodiment, the pressing pressure is adjusted by press cylinders 43 connected to the pressure rollers 42 and 44. The press cylinders 43 drive at least one of the pressure rollers 42 and 44 upward or downward to thereby adjust the gap between the pressure rollers 42 and 44. As a result, the pressing pressure to the electrode sheet 10 is adjusted. The pressing pressure to the electrode sheet 10 may vary depending on the amount of the electrode active material layer 14 formed on the electrode sheet 10 that passes through the gap between the pressure rollers 42 and 44 and the size of the gap between the pressure rollers 42 and 44. The compression device 40 may also be provided with a pressure gauge, not shown, for measuring the pressing pressure. In this embodiment, the pressure gauge is provided inside a hydraulic system of the compression device 40. The change over time of the pressing pressure is transmitted to the controller 90. In addition, the gap between the pressure rollers 42 and 44 is adjusted according to the measured pressing pressure. For example, the greater the amount of the electrode active material layer 14 per unit length of the electrode sheet 10 is, the higher the pressing pressure is, and the less the amount of the electrode active material layer 14 per unit length of the electrode sheet 10 is, the lower the pressing pressure is. In the compression device 40, the shift amount of the press cylinders 43 is controlled so that the gap between the pressure rollers 42 and 44 becomes narrower when the pressing pressure is higher and the gap between the pressure rollers 42 and 44 becomes wider when the pressing pressure is lower. Variations in the thickness of the electrode active material layer 10 can be reduced by compressing portions of the electrode sheet 10 in which the amount of the electrode active material layer 14 is relatively greater are compressed at a higher pressing pressure.

It is possible to provide a pre-pressing stretching device that preliminarily compresses the electrode sheet 10 before compression upstream of the compression device 40. It is also possible to provide a post-pressing stretching device that adjusts the thickness of the electrode sheet 10 after compression downstream of the compression device 40.

### Film Thickness Gauge 50

The film thickness gauge 50 is a device that measures the in-line film thickness of the electrode sheet 10 after having been compressed by the compression device 40. The film thickness gauge 50 measures the film thickness of a portion of the electrode sheet 10 in which the electrode active material layer 14 is formed. The film thickness gauge 50 is not limited to any particular device as long as it can measure the thickness of the electrode sheet 10 that is conveyed. In this embodiment, a device that is capable of measuring film thickness in a non-contact manner is used as the film thickness gauge 50. The film thickness gauge 50 may be able to measure the thickness at one location or a plurality of locations of the electrode sheet 10 in its widthwise direction, or a predetermined area or the entire area thereof in the widthwise direction. The film thickness of the electrode sheet 10 that has been measured is transmitted to the controller 90. After the film thickness has been measured, the electrode sheet 10 conveyed to the tab formation device 60.

### Tab Formation Device 60

The tab formation device 60 is a device that forms tabs 12b (see FIG. 2) at predetermined positions of the electrode sheet 10 that is conveyed by the conveyor device 20. The tab formation device 60 forms tabs 12b on the electrode sheet 10 that has been compressed by the compression device 40. In the tab formation device 60, laser light is applied to the electrode sheet 10. This makes it possible to form tabs 12b in a predetermined shape at a predetermined pitch on the electrode sheet 10. The pitch, dimensions, or the like of the tabs 12b formed by the tab formation device 60 are not particularly limited, but may be set as appropriate according to the configuration of the electrode assembly to be obtained.

In this embodiment, the tabs 12b protrude outward in a widthwise direction from an end portion of the uncoated portion 12a of the current collector foil 12 (see FIG. 2). Each of the tabs 12b has a substantially trapezoidal shape with its width being gradually narrower from the base end toward the tip end. The shape of the tabs 12b is not limited to a particular shape, and may be, for example, a substantially rectangular shape. The pitch between the tabs 12b may be predetermined according to the configuration of the electrode assembly. When the electrode assembly is what is called a stacked electrode assembly, the pitch between the tabs 12b may be set to a constant pitch. Note that the stacked electrode assembly has a configuration in which a plurality of positive electrode sheets and a plurality of negative electrode sheets are stacked with separators interposed therebetween. When the electrode assembly is what is called a wound electrode assembly, the pitch between the tabs 12b may varied along a lengthwise direction of the electrode sheets. The pitch between the tabs 12b may be set such as to be gradually wider or narrower along the lengthwise direction of the electrode sheets so that a plurality of tabs 12b can be overlapped when the electrode sheet 10 is wound. Note that the wound electrode assembly is an electrode assembly in which a strip-shaped positive electrode sheet and a strip-shaped negative electrode sheet are stacked and wound with a strip-shaped separator interposed therebetween.

The tab formation device 60 may be disposed inside a tab processing chamber 65. The interior of the tab processing chamber 65 is isolated from outside by an outer wall. The tab processing chamber 65 is provided with an inlet 65a and an outlet 65b.

FIG. 3 is a schematic view illustrating the tab formation device 60. As illustrated in FIG. 3, the tab formation device 60 includes a chamber 61, a laser oscillator 62, and a scanner 63. The electrode sheet 10 is conveyed from an inlet 61a toward an outlet 61b of the chamber 61. In this embodiment, the conveyance passage of the electrode sheet 10 is determined so that the electrode sheet 10 is conveyed downward from above.

The chamber 61 surrounds the space in which tabs 12b are to be formed on the electrode sheet 10. In this embodiment, the electrode sheet 10 is conveyed within the chamber 61 at a substantially constant speed. In the chamber 61, a plurality of guide rollers 61c, a belt 61d, and a guide roller 61e are provided. The plurality of guide rollers 61c are rollers that guide the electrode sheet 10 conveyed from the inlet 61a of the chamber 61. The guide roller 61e is a roller that guides the electrode sheet 10 conveyed toward the outlet 61b. Because both faces of the electrode sheet 10 are conveyed along the plurality of guide rollers 61c and the guide roller 61e, unsteady movements of the electrode sheet 10 are reduced while the electrode sheet 10 is being conveyed.

The electrode sheet 10 conveyed in the chamber 61 is irradiated with laser light from the laser oscillator 62. The wavelength, frequency, power, and the like of the laser light are determined as appropriate. The laser oscillator 62 is fitted to the scanner 63. The scanner 63 controls irradiation angle of the laser light. By controlling the irradiation angle of the laser light with the scanner 63, a laser trajectory L applied to the electrode sheet 10 may be determined. The scanner 63 may be fitted to a moving device, not shown, that moves along planar directions of the electrode sheet 10. The laser trajectory L may be determined by the position of the scanner 63 and the laser irradiation angle determined by the scanner 63. In this embodiment, the laser trajectory L is controlled by the controller 90.

The controller 90 may be, for example, a microcomputer. The controller 90 includes, for example, a communication interface, a CPU, a ROM, and a ROM. The controller 90 controls the laser trajectory L by controlling the laser oscillator 62 and the scanner 63. The controller 90 may be configured to be able to control other facilities provided in the electrode manufacturing apparatus 1, such as the conveyor device 20, for example.

As illustrated in FIG. 2, substantially trapezoidal tabs 12b in the same shape are formed on both widthwise edges in the uncoated portions 12a of the electrode sheet 10. It is also possible that two laser oscillators 62 (see FIG. 3) may be connected to the scanner 63 (see FIG. 3). The laser trajectory L may be controlled so as to be line-symmetric on both edges of the uncoated portions 12a. It should be noted that the embodiments are not limited to one in which the tabs 12b of the same shape are formed on both edges of the uncoated portions 12a. It is also possible that asymmetrical tabs may be formed in the two uncoated portions disposed along both side edges of the current collector foil. It is also possible that tabs may be formed in one of the uncoated portions of the current collector foil.

The tabs 12b are formed by applying laser light from the laser oscillator 62 to the electrode sheet 10 (the uncoated portion 12a in this embodiment) to cut the end portions. The laser trajectory L of the laser light applied to the electrode sheet 10 is controlled according to tab processing conditions preprogrammed in the controller 90 (see FIG. 1). The tab processing conditions are preprogrammed according to the configuration or the like of the electrode assembly to be obtained. The tab processing conditions include laser trajectory L that is determined according to the targeted shape, pitch, and the like. When forming tabs, the behaviors of the laser oscillator 62 and the scanner 63 are controlled sequentially according to the programmed tab processing conditions. This makes it possible to form tabs 12b in a predetermined shape at a predetermined pitch in the electrode sheet 10. The pitch and shape of the tabs 12b do not need to be uniform over all of the tabs 12b. In this embodiment, the pitch and shape of the tabs 12b are determined individually according to the positions or the like of the tabs that are arranged when forming the electrode assembly, and programmed in the processing conditions.

The tabs 12b may be formed in the electrode sheet 10 in the following manner. First, the electrode sheet 10 is conveyed into the chamber 61 (see FIG. 2). Next, laser light is applied to a reference position R on the uncoated portion 12a. The reference position R may be a position that serves as the starting point of the location at which laser light is to be applied. Subsequently, the laser oscillator 62 and the scanner 63 are controlled according to the first one of a plurality of processing conditions programmed in the controller 90 so that laser light is applied to the uncoated portion 12a along a predetermined laser trajectory L. Then, the laser trajectory L is determined so as to proceed toward the upstream end of the electrode sheet 10 by a predetermined distance G (for example, the distance between adjacent tabs 12b). As a result, a portion that is outward of the position at which laser light is applied is cut off, and a side face 12a1, which is the base end of a tab 12b, is formed. Application of laser light is stopped, and the electrode sheet 10 is conveyed by a predetermined length. The cut-off end of the electrode sheet 10 is conveyed to the reference position R. The laser oscillator 62 (see FIG. 1) and the scanner 63 (see FIG. 1) are controlled according to the next one of the processing conditions so that laser light is applied to the uncoated portion 12a along a predetermined laser trajectory L, starting from the reference position R. The electrode sheet 10 is conveyed again by a predetermined length. By repeating the above-described operation, tabs 12b are sequentially formed in the uncoated portion 12a of the electrode sheet 10. The fragments of the uncoated portion 12a of the current collector foil 12 that are cut off by the laser from the electrode sheet 10 may be adsorbed by the belt 61d (see FIG. 3). The belt 61d is provided, for example, at both widthwise end portions of the electrode sheet 10. The fragments adsorbed by the belt 61d may be conveyed outside the chamber 61 and collected by a waste material separation device, not shown.

Here, the conveying amount of the electrode sheet 10 when forming the tabs 12b in the tab formation device 60 is measured by a rotation encoder 70 (see FIG. 1).

### Rotation Encoder 70

As illustrated in FIG. 1, the rotation encoder 70 is provided for the roller 71, one of the pair of rollers 71 and 72 that are disposed downstream of the tab formation device 60. The conveyance passage of the electrode sheet 10 is set along the roller 71. The roller 71 is configured to rotate in association with the conveying of the electrode sheet 10. The roller 72 is a pressing roller that presses the electrode sheet 10 against the roller 71. The roller 72 is configured to be rotated by a rotary driving device, not shown. This makes it easier to match rotation of the roller 71 and conveying of the electrode sheet 10. The rotation encoder 70 detects the number of rotations of the roller 71 when the electrode sheet 10 is conveyed. The number of rotations of the roller 71 is transmitted to the controller 90.

Based on the number of rotations that has been received, the controller 90 calculates the conveying amount of the electrode sheet 10. The controller 90 drives the conveyor device 20 based on the calculated conveying amount to convey the electrode sheet 10. The controller 90 calculates the conveying amount of the electrode sheet 10 based on the number of rotations of the roller 71, the radius of the roller 71, and the thickness of the electrode sheet 10. The conveying amount of the electrode sheet 10 may be calculated, for example, according to the following equation.

Equation: Conveying amount=2π×(Radius of roller 71+Half the thickness of electrode sheet 10)×Number of rotations of roller 71

Note that the film thickness of the electrode sheet 10 after having been compressed by the compression device 40 is not necessarily uniform along its lengthwise direction. The film thickness of the electrode sheet 10 along its lengthwise direction may vary depending on variations in the coated electrode active material layer 14, variations in the pressing pressure applied to the electrode active material layer 14 during compression, and the like. In this embodiment, the measured in-line film thickness of the electrode sheet 10 is transmitted to the controller 90. The controller 90 is configured to control the conveying amount of the electrode sheet 10 based on the in-line film thickness. The controller 90 may input the in-line film thickness measured by the film thickness gauge 50 as “thickness of electrode sheet 10” in the foregoing equation, to control the conveying amount of the electrode sheet 10. The controller 90 controls the conveyor device 20 so that the greater the measured in-line film thickness is, the greater the conveying amount of the electrode sheet 10 becomes. This makes it easier to adjust the conveying amount of the electrode sheet 10 irrespective of variations in thickness of the electrode sheet 10 along its lengthwise direction. As a result, the pitch between the tabs 12b formed by the tab formation device 60 is made more stable.

Subsequently, the electrode sheet 10 is conveyed toward the shape acquisition device 80. A half-cutting device 75 may be disposed between the tab formation device 60 and the shape acquisition device 80. The half-cutting device 75 is a device that cuts the electrode sheet 10 formed with tabs 12b at a widthwise central portion, which is also referred to as a slitter. Because the electrode sheet 10 is cut at the widthwise central portion, one end is provided with tabs 12b in the widthwise direction of the electrode sheet 10 while the other end is not provided with the uncoated portion 12a. One of the electrode sheet 10 that is cut in half and the other one of the electrode sheet 10 are taken up to different winding rollers 22, respectively. The electrode sheet 10 that is cut in half may be conveyed to an edge cleaner, not shown, that removes dust on the end portions and thereafter conveyed to the shape acquisition device 80.

### Shape Acquisition Device 80

The shape acquisition device 80 is a device that acquires shape data of the electrode sheet 10. The shape acquisition device 80 acquires an image of the electrode sheet 10, carries out image inspection, and outputs the results of the inspection. Herein, the shape acquisition device 80 acquires shape data of the electrode sheet 10 after having been compressed by the compression device 40 and provided with tabs 12b. The shape acquisition device 80 includes cameras 81 and 82 and a processing unit 84.

The cameras 81 and 82 respectively acquire different shape data. The camera 81 is a line-scan camera that is capable of imaging the electrode sheet 10 from one end to the other end along a widthwise direction of the electrode sheet 10. The camera 81 acquires image data of the electrode sheet 10 that is being conveyed and transmits the acquired data to the processing unit 84. The processing unit 84 converts the image data of the electrode sheet 10 transmitted from the camera 81 into dimensional data. In this embodiment, the image data transmitted from the camera 81 are converted into width dimensions of the electrode sheet 10. The processing unit 84 records the width dimensions of the electrode sheet 10 in association with the lengthwise positional information of the electrode sheet 10. This means that the processing unit 84 records the width dimensions of the electrode sheet 10 at respective lengthwise positions.

The camera 82 is an area scan camera that is capable of imaging the tabs 12b of the electrode sheet 10. The camera 82 acquires image data of the tabs 12b of the electrode sheet 10 that is being conveyed and transmits the acquired data to the processing unit 84. In this embodiment, the processing unit 84 converts the image data transmitted from the camera 82 into dimensional data. The dimensions of the tabs 12b may include the height, width, and angle of tab 12b, the pitch between adjacent tabs 12b, and the like. As with the width dimensions of the electrode sheet 10, the processing unit 84 records the dimensions of the tabs 12b in association with the lengthwise positional information of the electrode sheet 10. This means that the processing unit 84 records the dimensions of the tabs 12b, in addition to the width dimensions of the electrode sheet 10, at respective lengthwise positions. The shape data of the electrode sheet 10 may contain the width dimensions of the electrode sheet 10 and the dimensions of the tabs 12b. The shape data that have been processed and recorded by the processing unit 84 of the shape acquisition device 80 are transmitted to the controller 90.

It is also possible that the shape acquisition device 80 may be configured to acquire data of the electrode sheet 10 other than its shape. For example, the shape acquisition device 80 may be configured to acquire the external appearance of the electrode sheet 10 in addition to the shape data. As the external appearance of the electrode sheet 10, it is possible to acquire the conditions, such as peeling, of the electrode active material layer 14. The electrode sheet 10 the shape data of which are acquired by the shape acquisition device 80 is conveyed to the winding rollers 22 and taken up on the winding rollers 22. It is also possible that a foreign matter removal device, not shown, may be provided between the shape acquisition device 80 and the winding rollers 22, as well as between the feed roller 21 and the compression device 40.

The wound electrode sheet 10, with it being wound on a winding roller 22, is sent to the next step. Although the detailed description is not provided, an electrode assembly is manufactured through a cutting step, a winding step, a shape-forming step, and the like. In the cutting step, the electrode sheet 10 is taken out from the winding roller 22 and cut out into a predetermined length. In the winding step, the electrode sheet 10 is wound together with an electrode sheet of the other electrode and a separator interposed therebetween so that the tabs 12b of the electrode sheet 10 overlap, to produce a wound assembly. In the shape-forming step, the wound assembly is subjected to press-forming and shaped into a flat shape. It should be noted that the steps of manufacturing an electrode assembly are not limited to the above-described embodiment. The manufactured electrode assembly is accommodated in a case. The case accommodating the electrode assembly is filled with an electrolyte solution, to manufacture an electricity storage device assembly. The electricity storage device assembly is subjected to various processes to manufacture an electricity storage device.

According to the knowledge of the present inventor, in an electricity storage device that employs an electrode in which a plurality of tabs are overlapped, the stability of processing of tabs affects the performance of the electricity storage device. In cases where the processing of tabs is instable, there is a risk of welding defects occurring at the time of welding of tabs. According to trails conducted by the present inventor, it has been found that the pitch, shape, dimensions, and the like of tabs may deviate from target values (set values) even when a tab formation device is controlled based on processing conditions according to the target values for the pitch, shape, dimensions, and the like of tabs to form the tabs on an electrode sheet. From the trials conducted by the present inventor, it has been found that the electrode sheet may undergo deformation before and after the processing, before and after the winding, and so forth, depending on the processing conditions in production. Consequently, the pitch, shape, dimensions, and the like of tabs may also be adversely affected so that they may deviate from the target values.

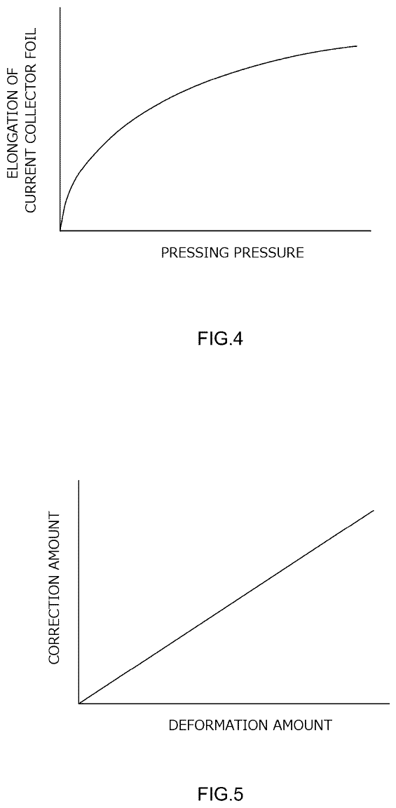

FIG. 4 is a graph illustrating the relationship between the pressing pressure and the elongation of a current collector foil. In FIG. 4, “pressing pressure” indicates pressing pressure when an electrode active material layer is compressed. In FIG. 4, “elongation of current collector foil” indicates the amount of elongation of the current collector foil in a state in which an electrode sheet after the electrode active material layer has been compressed is wound on a winding roller. According to the knowledge of the present inventor, the phenomenon in which the current collector elongates after the compressed electrode sheet has been taken up on a winding roll may occur when, for example, the stress that has acted on the electrode sheet during compression is reduced in a state in which the electrode sheet is taken up on the winding roller. Accordingly, as shown in FIG. 4, the higher the pressing pressure is when the electrode active material layer is compressed, the greater the elongation of the current collector foil after the compressed electrode sheet is taken up on the winding roller. However, the higher the pressing pressure is, the less the rate of increase of elongation of the current collector foil becomes. Such a relationship between the pressing pressure and the elongation of current collector foil may vary depending on the conditions of the electrode sheet, such as materials and dimensions. When the pressing pressure is high, the current collector foil of the electrode sheet that has been taken up on a winding roller does not necessarily elongate. Depending on the material of the electrode sheet, the current collector foil of the electrode sheet taken up on a winding roller may contract. Therefore, the relationship between the pressing pressure and the deformation of the current collector foil may desirably be obtained in advance according to the electrode sheet to be manufactured, through testing, simulation, or the like.

In the embodiment shown in FIG. 1, the electrode manufacturing apparatus 1 includes a conveyor device 20, a compression device 40, a tab formation device 60, and a controller 90. The conveyor device 20 conveys the electrode sheet 10. The compression device 40 compresses the electrode sheet 10 conveyed by the conveyor device 20. The tab formation device 60 forms tabs 12b in the electrode sheet 10 that is conveyed by the conveyor device 20 after the electrode sheet 10 has been compressed by the compression device 40. The electrode sheet 10 includes a strip-shaped current collector foil 12 in which an uncoated portion 12a is defined along a lengthwise direction in a widthwise end portion, and an electrode active material layer 14 formed on a portion of the strip-shaped current collector foil 12 that is other than the uncoated portion 12a. The compression device 40 includes a pair of pressure rollers 42 and 44 that sandwiches the electrode sheet 10 and compresses the electrode active material layer 14. The tab formation device 60 is a device that applies laser light to the electrode sheet 10 to form tabs 12b in a predetermined shape at a predetermined pitch. Herein, the controller 90 is configured to control a laser trajectory for the tab formation device 60 based on the pressing pressure of the compression device 40.

As described above, the pressing pressure applied to the electrode active material layer 14 of the electrode sheet 10 by the pressure rollers of the compression device 40 is transmitted to the controller 90. The controller 90 controls the laser trajectory for the tab formation device 60 based on the pressing pressure that has been received. FIG. 5 is a graph illustrating the relationship between the deformation amount of a current collector foil 12 and the correction amount of the pitch between tabs 12b. As illustrated in FIG. 5, the controller 90 corrects the laser trajectory L so that the greater the deformation amount of the current collector foil 12 (the elongation of the current collector foil 12 in this embodiment) with the electrode sheet 10 being taken up on a winding roller 22 is, the correction amount for the pitch between the tabs 12b becomes. Herein, increasing the correction amount corresponds to decreasing the pitch between the tabs 12b. For example, because the higher the pressing pressure is, the greater the elongation of the current collector foil 12 after taking-up becomes (see FIG. 4), the pitch between adjacent tabs 12b may be greater correspondingly. The controller 90 corrects the laser trajectory L so that the greater the elongation of the current collector foil 12 is, the less the pitch between adjacent tabs 12b becomes. This stabilizes the pitch between the tabs 12b after the current collector foil 12 has been deformed. The correction of the laser trajectory L may be implemented by, for example, controlling either one of the laser oscillator 62 and the scanner 63. The correction of the laser trajectory Lis incorporated in the tab processing conditions recorded in the controller 90. The pitch between the tabs 12b is stabilized by incorporating the deformation of the current collector foil 12 effected by compression of the electrode active material layer 14 into the processing conditions. It is also possible that the shape, dimensions, and the like may be corrected, in addition to the pitch between the tabs 12b,

The electrode manufacturing apparatus 1 may control the formation of the tabs 12b based on various conditions other than the pressing pressure in the compression device 40.

As described above, the electrode manufacturing apparatus 1 includes the shape acquisition device 80 that acquires shape data of the electrode sheet 10. The controller 90 is configured to control the laser trajectory L for the tab formation device 60 based on the shape data acquired by the shape acquisition device 80. As described above, the shape data of the electrode sheet 10 that have been processed and recorded by the processing unit 84 of the shape acquisition device 80 are transmitted to the controller 90. The controller 90 controls the laser trajectory L for the tab formation device 60 based on the received shape data. The controller 90 verifies the processing conditions executed when forming tabs 12b with the shape data of the electrode sheet 10. When the deviation between the processing conditions and the shape data is great, the processing conditions are corrected, and the laser trajectory L is controlled. For example, when the difference between the target tab dimensions based on the processing conditions and the dimensions of the actually formed tabs 12b is greater than a predetermined threshold value, the laser trajectory L is controlled so that the dimensions of the tabs 12b to be formed become closer to the pitch, dimensions, and the like of the target tabs. Thus, the shape data acquired by the shape acquisition device 80 are fed back to the processing of tabs 12b in the tab formation device 60. This reduces dimensional variations of tabs 12b at the time of tab formation. As a result, the dimensions, shape, and the like of the tabs 12b may be stabilized.

As described above, the electrode manufacturing apparatus 1 includes the winding rollers 22 that take up the electrode sheet 10 after tabs 12b are formed by the tab formation device 60. The controller 90 may acquire the length of the electrode sheet 10 that has been taken up on the winding rollers 22 based on the conveying amount of the electrode sheet 10. It is also possible that the controller 90 may accumulate the conveying amount of the electrode sheet 10 to thereby acquire the length of the electrode sheet 10 that has been taken up. The controller 90 is configured to correct the laser trajectory L for the tab formation device 60 based on the radius of the electrode sheet 10 that has been taken up on the winding roller 22. It is also possible that the radius of the electrode sheet 10 taken up on the winding roller 22 may be directly measured by a displacement gauge and sent to the controller 90.

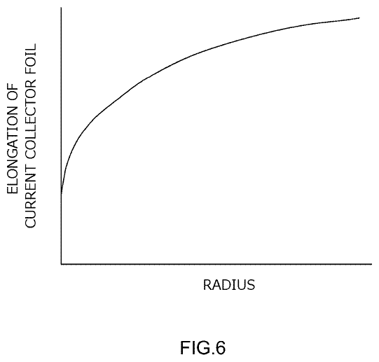

FIG. 6 is a graph illustrating the relationship between the radius of an electrode sheet and the elongation of a current collector foil. The term “radius of an electrode sheet” means the distance from the central axis of a winding roller to the position on which the electrode sheet is taken up. When the electrode sheet is taken up on the winding roller, the electrode sheet may be under a stress corresponding to the distance from the axis of the winding roller. As a consequence, as shown in FIG. 6, the farther away from the axis of the winding roller, the greater the elongation of the current collector foil after taking-up. However, the farther away from the axis of the winding roller is, the less the rate of increase of elongation of the current collector foil becomes. Such a relationship between the distance from the axis of the winding roller and the elongation of the current collector foil may vary depending on the conditions of the electrode sheet, such as materials and dimensions. Therefore, the relationship between the distance from the axis of the winding roller and the elongation of the current collector foil may be obtained according to the electrode sheet to be manufactured, through testing, simulation, or the like. The controller 90 corrects the laser trajectory L based on the relationship between the length of the electrode sheet that has been taken up and the elongation of the current collector foil. For example, because the farther away from the winding roller 22 the more the current collector foil 12 elongates, the laser trajectory L is corrected so that the pitch between the tabs 12b becomes smaller. The correction of the laser trajectory L is incorporated in the tab processing conditions recorded in the controller 90. This may stabilize the pitch between the tabs 12b.

Various embodiments of the technology according to the present disclosure have been described hereinabove. Unless specifically stated otherwise, the embodiments described herein do not limit the scope of the present disclosure. It should be noted that various other modifications and alterations may be possible in the embodiments of the technology disclosed herein. In addition, the features, structures, or steps described herein may be omitted as appropriate, or may be combined in any suitable combinations, unless specifically stated otherwise. In addition, the present description includes the disclosure as set forth in the following items.

### Item 1:

An electrode manufacturing apparatus including:
a conveyor device conveying an electrode sheet;
a compression device compressing the electrode sheet conveyed by the conveyor device;
a tab formation device forming tabs on the electrode sheet conveyed by the conveyor device after the electrode sheet is compressed by the compression device; and
a controller, wherein:
the electrode sheet includes a strip-shaped current collector foil in which an uncoated portion is defined along a lengthwise direction in at least one widthwise end portion of the electrode sheet, and an electrode active material layer formed on a portion of the strip-shaped current collector foil that is other than the uncoated portion;
the compression device includes a pair of pressure rollers sandwiching the electrode sheet and compressing the electrode active material layer;
the tab formation device forms the tabs in a predetermined shape at a predetermined pitch by applying laser light to the electrode sheet; and
the controller is configured to control a laser trajectory for the tab formation device based on a pressing pressure applied to the electrode sheet by the compression device.

### Item 2:

The electrode manufacturing apparatus according to item 1, further including:
a shape acquisition device acquiring shape data of the electrode sheet, and wherein
the controller is configured to control the laser trajectory for the tab formation device based on the shape data acquired by the shape acquisition device.

### Item 3:

The electrode manufacturing apparatus according to item 1 or 2, wherein the controller is configured to control a conveying amount of the electrode sheet based on an in-line film thickness of the electrode sheet after having been compressed by the compression device.

### Item 4:

The electrode manufacturing apparatus according to any one of items 1 through 3, further including:
a winding roller taking up the electrode sheet after the tabs are formed by the tab formation device, and wherein
the controller is configured to correct the laser trajectory for the tab formation device based on a radius of the electrode sheet taken up on the winding roller.

What is claimed is:

1. An electrode manufacturing apparatus comprising:
a conveyor device conveying an electrode sheet;
a compression device compressing the electrode sheet conveyed by the conveyor device;
a tab formation device forming tabs on the electrode sheet conveyed by the conveyor device after the electrode sheet is compressed by the compression device; and
a controller, wherein:
the electrode sheet includes a strip-shaped current collector foil in which an uncoated portion is defined along a lengthwise direction in at least one widthwise end portion of the electrode sheet, and an electrode active material layer formed on a portion of the strip-shaped current collector foil that is other than the uncoated portion;
the compression device includes a pair of pressure rollers sandwiching the electrode sheet and compressing the electrode active material layer;
the tab formation device forms the tabs in a predetermined shape at a predetermined pitch by applying laser light to the electrode sheet; and
the controller is configured to control a laser trajectory for the tab formation device based on a pressing pressure applied to the electrode sheet by the compression device.

2. The electrode manufacturing apparatus according to claim 1, further comprising:
a shape acquisition device acquiring shape data of the electrode sheet, and wherein
the controller is configured to control the laser trajectory for the tab formation device based on the shape data acquired by the shape acquisition device.

3. The electrode manufacturing apparatus according to claim 1, wherein the controller is configured to control a conveying amount of the electrode sheet based on an in-line film thickness of the electrode sheet after having been compressed by the compression device.

4. The electrode manufacturing apparatus according to claim 1, further comprising:
a winding roller taking up the electrode sheet after the tabs are formed by the tab formation device, and wherein
the controller is configured to correct the laser trajectory for the tab formation device based on a radius of the electrode sheet taken up on the winding roller.
